(19) United States
(12) Patent Application Publication
(10) Pub. No.: US 2023/0132786 A1
(43) Pub. Date: May 4, 2023

(54) ARTIFICIAL INTELLIGENCE BASED POWER CONSUMPTION OPTIMIZATION

(71) Applicant: RAKUTEN MOBILE, INC., Tokyo (JP)

(72) Inventors: Krishnakumar KESAVAN, San Mateo, CA (US); Alexander DORIA, San Mateo, CA (US); Manish SUTHAR, San Mateo, CA (US)

(73) Assignee: RAKUTEN MOBILE, INC., Tokyo (JP)

(21) Appl. No.: 17/514,066

(22) Filed: Oct. 29, 2021

(51) Int. Cl. H04L 12/24; G06N 20/20; G06K 9/62

(52) U.S. Cl. CPC H04L 41/16; G06N 20/20; G06K 9/628; G06K 9/6218

(57) ABSTRACT

An optimization apparatus that receives data related to operational characteristics of a plurality of devices in a network, classifies the plurality of devices in the network into a plurality of clusters based on the data, builds a plurality of artificial intelligence (AI) models, each of the AI models corresponding to one of the plurality of clusters, determines a predicted operational characteristic for a first device based on an AI model, among the AI models, corresponding to a cluster to which the first device belongs, and outputs a recommendation for the first device based on the predicted operational characteristics.

### TECHNICAL FIELD

The disclosure relates to an optimization apparatus, an optimization system, an optimization method, and a storage medium. More particularly, it relates to an optimization apparatus, an optimization system, an optimization method, and a storage medium for optimizing power consumption based on artificial intelligence. However, the disclosure is not limited to optimizing power consumption. For instance, one or more aspects of the disclosure may be applied in optimization of other features in an electronic device or a system.

### RELATED ART

In large networks, such as communication networks, numerous servers and/or devices may consume large amounts of power. This power consumption not only affects the functioning of the servers and the devices, but it also increases the cost for operating and maintaining the servers and devices.

Accordingly, there is a need for optimizing the power consumption of the servers and devices, particularly in large networks.

### SUMMARY

In a related art technology, one approach is to build a single model for power optimization for all servers. However, such an approach is not very ideal, since implementing a single model for all the servers does not take into account the differences between the features and functionalities of all the servers. According to another approach, an individual model may be built separately for each server. However, such an approach would not scalable. In some other cases, a rule based approach has be implemented, in which, rule-based algorithms (i.e., “put server X to sleep during midnight of every day”). However, such an approach is cumbersome and is not efficient.

As such, there is a need for an improved manner of optimizing one or more aspects of servers provided in large networks.

According to an aspect of the disclosure, there are provided apparatuses, methods and systems for implementing scalable, efficient and lightweight AI models to optimize server operation characteristics such as power consumption.

According to an aspect of the disclosure, there is provided an apparatus comprising: a memory storing one or more instructions; and a processor configured to execute the one or more instructions to: receive data related to operational characteristics of a plurality of devices in a network, classify the plurality of devices in the network into a plurality of clusters based on the data, build a plurality of artificial intelligence (AI) models, each of the AI models corresponding to one of the plurality of clusters, determine a predicted operational characteristic for a first device based on an AI model, among the AI models, corresponding to a cluster to which the first device belongs, and output a recommendation to operation based on the predict operation characteristics for the first device based on the predicted operational characteristics.

The processor is further configured to execute a clustering algorithm classify the plurality of devices in the network into the plurality of clusters.

Each of the plurality of AI models are tailored to one of the plurality of clusters.

The processor is further configured to control an operation parameter of a CPU of the first device based on the predicted operational characteristic.

The processor is further configured to set a clock frequency of a CPU of the first device based on the predicted operational characteristic.

The data comprises at least one of historical data including one of server parameters, metrics or key performance indicators.

The processor is further configured to classify the plurality of devices in the network into the plurality of clusters based on one or more patterns identified in the data.

The one or more patterns may be workload signature information, kernel statistics information, traffic pattern information, time information or location information.

According to another aspect of the disclosure, there is provided a method comprising: receiving data related to operational characteristics of a plurality of devices in a network; classifying the plurality of devices in the network into a plurality of clusters based on the data; building a plurality of artificial intelligence (AI) models, each of the AI models corresponding to one of the plurality of clusters; determining a predicted operational characteristic for a first device based on an AI model, among the AI models, corresponding to a cluster to which the first device belongs; and outputting a recommendation for the first device based on the predicted operational characteristics.

The method further comprising executing a clustering algorithm classify the plurality of devices in the network into the plurality of clusters.

Each of the plurality of AI models are tailored to one of the plurality of clusters.

The method further comprising controlling an operation parameter of a CPU of the first device based on the predicted operational characteristic.

The method further comprising setting a clock frequency of a CPU of the first device based on the predicted operational characteristic.

The data comprises at least one of historical data including one of server parameters, metrics or key performance indicators.

The method further comprising classifying the plurality of devices in the network into the plurality of clusters based on one or more patterns identified in the data.

The one or more patterns may be workload signature information, kernel statistics information, traffic pattern information, time information or location information.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

These and/or other aspects will become apparent and more readily appreciated from the following description of the embodiments, taken in conjunction with the accompanying drawings in which:

FIG. 1A illustrates a network including a plurality of servers according to an example embodiment of the disclosure;

FIG. 1B illustrates a detailed diagram of a server including according to an example embodiment of the disclosure;

FIG. 2A illustrates an apparatus according to an example embodiment of the disclosure;

FIG. 2B illustrates a connection between an apparatus and a plurality of servers according to another example embodiment of the disclosure;

FIG. 2C illustrates a detailed diagram of an apparatus according to an example embodiment of the disclosure;

FIG. 3 is a chart illustrating clusters of servers according to an example embodiment of the disclosure;

FIG. 4 illustrates operating states of the servers according to an example embodiment;

FIG. 5 illustrates a method of optimization according to an example embodiment of the disclosure;

FIG. 6 illustrates a process flow according to an example embodiment of the disclosure; and

FIGS. 7 and 8 are graphs illustrating a level of accuracy of the prediction according to example embodiments.

### DESCRIPTION OF EXAMPLE EMBODIMENTS

Example embodiments will now be described below in more detail with reference to the accompanying drawings. The following detailed descriptions are provided to assist the reader in gaining a comprehensive understanding of the methods, apparatuses, and/or systems described herein. However, the example embodiment provided in the disclosure should not be considered as limiting the scope of the disclosure. Accordingly, various changes, modifications, and equivalents of the systems, apparatuses and/or methods described herein will be suggested to those of ordinary skill in the art.

The terms used in the description are intended to describe embodiments only, and shall by no means be restrictive. Unless clearly used otherwise, expressions in a singular form include a meaning of a plural form. In the present description, an expression such as “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

One or more example embodiments of the disclosure will be described below with reference to the drawings. Throughout the drawings, the same components or corresponding components are labeled with the same reference numerals, and, accordingly, the description thereof may be omitted or simplified.

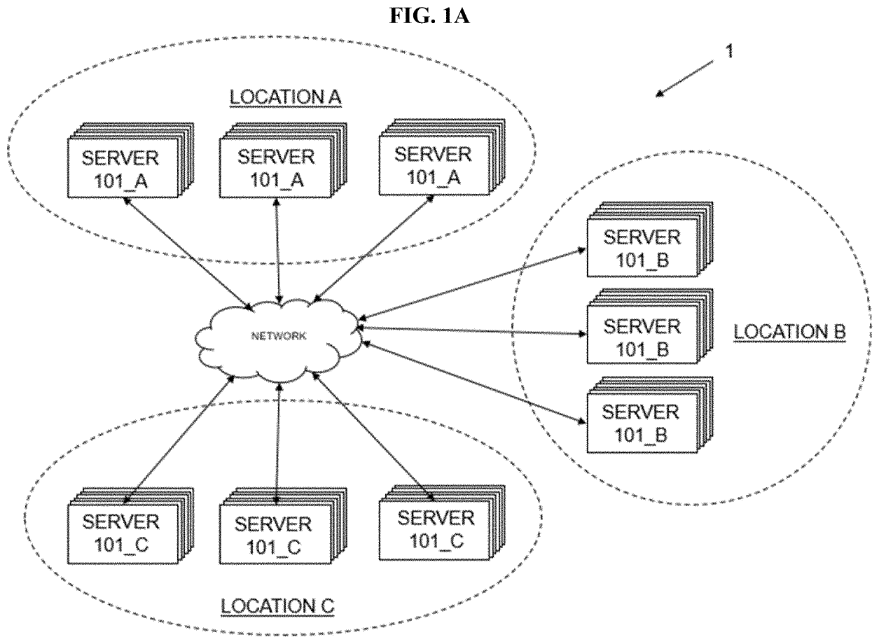

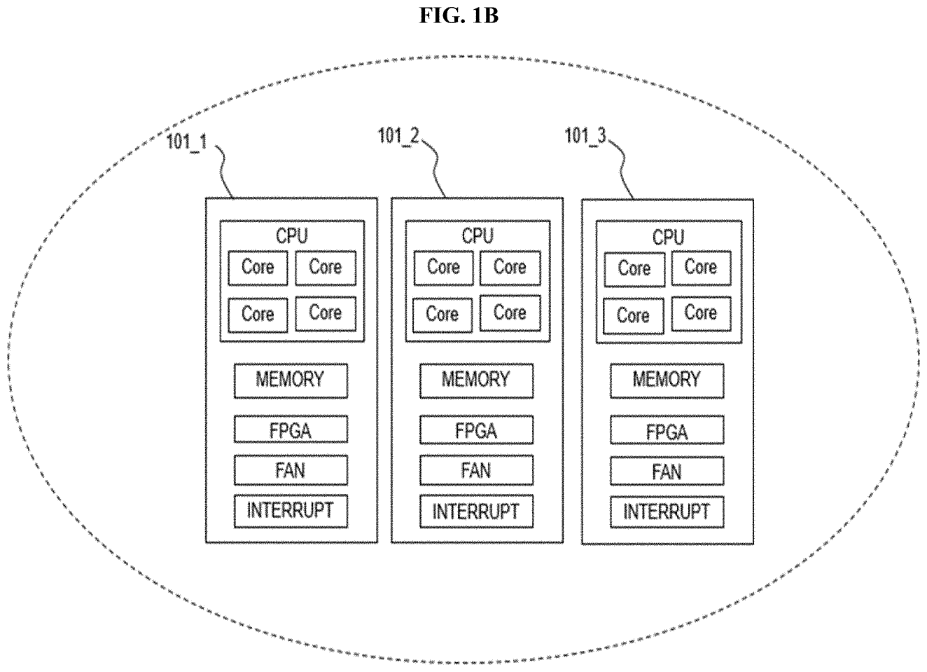

FIG. 1A illustrates a network 1 including a plurality of servers 101. According to an example embodiment, the network 1 may be a communication network for facilitating communication between the plurality of servers 101. For instance, the network 1 may be a large network serving millions of electronic devices, such as user equipment (UE). As an example, the network 1 may be part of a cellular radio system or an internet service provider system in a large metropolitan area, which uses hundreds of servers transmission of information or data. Although a plurality of servers are illustrated in FIG. 1A, the disclosure is not limited thereto, and as such, according to another example embodiment, the network may include telecommunication devices, such as base stations, or other electronic devices such as servers, computers, mobile devices etc.,

According to an example embodiment, the plurality of servers in the network may be located at different geographical regions. For instance, as illustrated in FIG. 1A, servers 101_A, may be located at location A, servers 101_B, may be located at location B, and servers 101_C, may be located at location C. According to an example embodiment, locations A, B and C may be physical locations. However, the disclosure is not limited thereto, and as such, according to another example embodiment, the plurality of servers 101 may be cloud-based virtual machines (VMs).

FIG. 1B illustrates the cloud of servers including, among many servers, server 101_1, server 101_2 and server 101_3. Internal representative hardware of a servers 101_1, 101_2 and 101_3 are illustrated. Each of these servers 101_1, 101_2 and 101_3 may include a CPU, and the CPU may include a plurality of cores. For instance, the CPU may include core 1, core 2, core 3, . . . core n (where is an integer). Each core of the CPU can perform operations separately from the other cores. Or, multiple cores of the CPU may work together to perform parallel operations on a shared set of data in the CPU's memory cache (e.g., a portion of memory). According to an example embodiment, the server 101_1 may have, for example, 80 cores. However, the disclosure is not limited thereto, and as such, different number of cores may be provided. The server 101_1 may also include one or more fans which provide airflow, FPGA chips, and interrupt hardware. The components illustrated in FIG. 1B are exemplary, and as such, other servers of the disclosure may add other components and/or or omit one or more of the components illustrated in FIG. 1B.

Since network 1 employs large numbers of servers 101, there is a need for optimizing power consumption of the servers 101. However, related art power optimization systems fail to provide a scalable, efficient and lightweight system optimize server power consumption. According to an example embodiment, there is provided a scalable, efficient and lightweight system, implemented by artificial intelligence (AI) models, to optimize server power consumption. For instance, according to an example embodiment, AI models are generated by taking into account differences in features and functionalities between the servers 101. For instance, a servers 101_A at location A may have one or more first characteristics different from one or more second characteristics of a servers 101_B at location B. Therefore, the operation and the power consumption characteristics may vary. However, the disclosure is not limited thereto, and as such, according to another example embodiment, there may be characteristic differences between the servers 101_A at location A. For example, the servers 101 different workloads running different protocols. As such, the operation and the power consumption characteristics may vary between the servers 101_A at location A.

According to an example embodiment, an optimization apparatus performs a clustering operation to capture the patterns across multiple servers 101, across different geographical regions and/or multiple workloads running different protocols based on their workload signatures, time of the day patterns, network traffic patterns, kernel statistics, etc. Based on the captured patterns, the optimization apparatus clusters the multiple servers 101 according to the captured patterns. Thereafter, the optimization apparatus builds an AI model for each cluster of servers to take advantage of patterns that are specific to each cluster. Accordingly, a plurality of AI models are deployed, each of the AI models corresponding to each of the respective servers in each of the respective clusters, such that, a same AI model is used for each sever in a respective cluster. For instance, a first AI model corresponding to a first cluster is deployed with respect to a first server in the first cluster and a second AI model corresponding to a second cluster is deployed with respect to a second server in the second cluster.

According to an example embodiment, the AI models may predict one or more future characteristics of the servers 101. For instance, the first AI model may predict one or more characteristics of one or more servers in the first cluster in the future, and the second AI model may predict one or more characteristics of one or more servers in the second cluster in the future. According to an example embodiment, one or more characteristics may be traffic on each of the servers over a period of time in the future. According to an example embodiment, one or more characteristics may be traffic on each core of the servers. For instance, the first AI model may predict the traffic on each core of the one or more servers in the first cluster over the next ten minutes. However, the disclosure is not limited thereto, and as such, according to other example embodiments, one or more characteristics may be different from the traffic and the period of time may be different from ten minutes. For instance, according to another example embodiment, the one or more characteristics may be a processing load on each core of the one or more servers in the future. According to an example embodiment, the core of the server may be a Central Processing Unit (CPU) of the server. However, the disclosure is not limited thereto, and as such, one or more characteristics other types processors, or other electronic circuitry may be predicted.

According to an example embodiment, the optimization apparatus may output setting information corresponding to one or more features and/or functionalities of the servers based on the predicted one or more characteristics of the servers. For instance, the setting information may correspond to a CPU frequency based on the predicted one or more characteristics of the servers.

However, the disclosure is not limited thereto, and as such, according to another example embodiment, the setting information may indicate a state of one or more servers based on the predicted one or more characteristics of the servers. For example, the setting information may indicate an operation state of the servers. According to an example embodiment, the setting information may indicate that the one or more servers operate in a certain state, among a plurality of operation states. The operation state indicated in the setting information being determined based on the predicted one or more characteristics of the servers. According to an example embodiment, the operation state may be related to the processing frequency of the CPU. For instance, the operation states may be a first state, in which, the CPU frequency is set to 2.6 GHz, a second state, in which, the CPU frequency is set to or 2 GHZ or a third state, in which, the CPU frequency is set to 1.6 GHz. However, the disclosure is not limited thereto, and the operation states may be related to other features or functionalities of the servers.

According to an example embodiment, the optimization apparatus may control one or more servers based on the predicted one or more characteristics of the servers. For instance, optimization apparatus may output instruction to control the core of the one or more servers to operate at a specific frequency. According to another example embodiment, the optimization apparatus may output a recommendation to operate the one or more servers in a particular manner based on the predicted one or more characteristics of the servers.

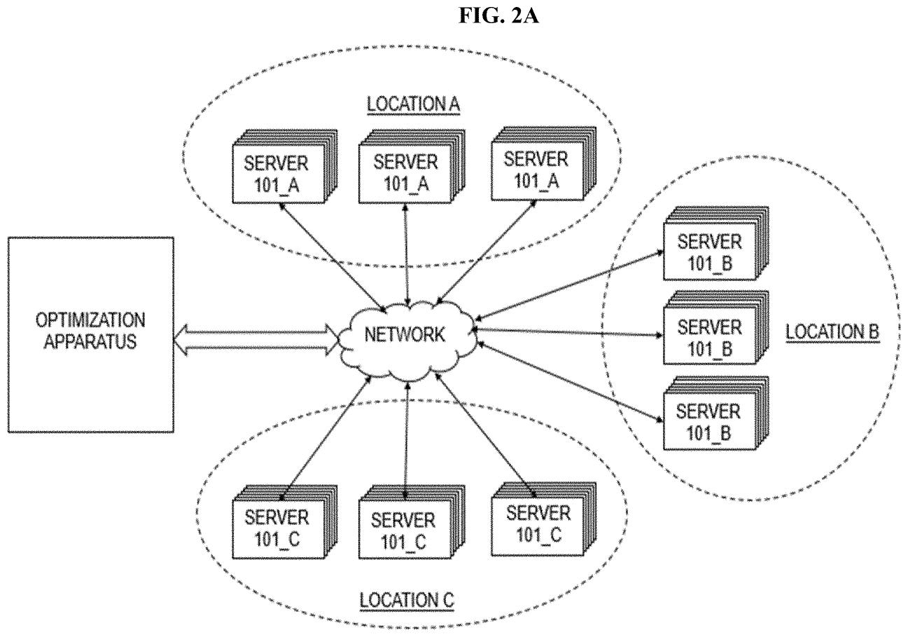

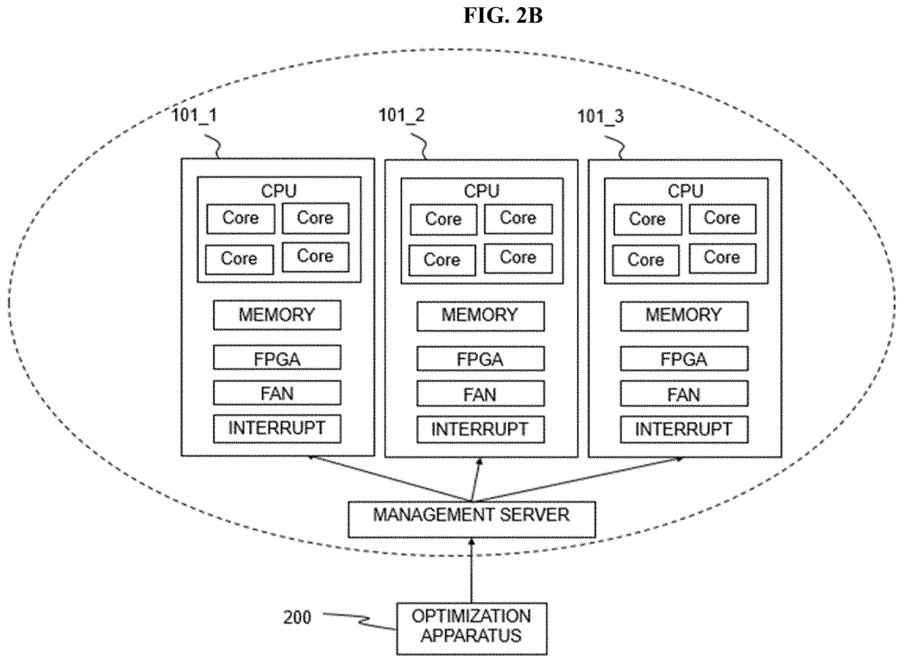

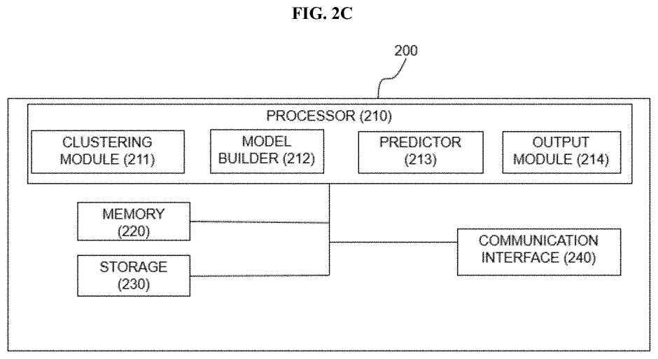

FIG. 2A illustrates an apparatus 200 according to an example embodiment of the disclosure. The apparatus 200 may be configured to build scalable, efficient and lightweight AI models to manage, control and/or optimize one or more servers 100 of the network 1. According to an example embodiment, the apparatus 200 may include a processor 210, a memory 220, a storage 230 and a communication interface 240. However, the disclosure is not limited to the arrangement of components illustrated in FIG. 2A. For instance, according to another example embodiment, according to an example embodiment, the apparatus may further include a display, a input/output (I/O) interface, or a bus line that connects the components of the apparatus 200. As such, according to another example embodiment, the other components or may be included in the apparatus 200 or omitted from the apparatus 200.

According to an example embodiment, the processor 210 may be CPU, a graphic processing unit (GPU) or other processing circuitry. According to an example embodiment, the memory 220 may include a random access memory (RAM) or other types of memory. According to an example embodiment, the storage 230 may be formed of a storage medium such as a non-volatile memory, a hard disk drive, or the like and functions as a storage unit. According to an example embodiment, the communication interface 240 may include a transceiver configured to transmit and receive data from one or more devices external to the apparatus 200. According to an example embodiment, the communication interface 240 may include electronic components and/or circuitry to perform wireless communication with the one or more external devices.

According to an example embodiment, the storage 230 stores a program for performing one or more operations to build AI models to manage, control and/or optimize one or more servers 100 of the network 1. According to an example embodiment, the program may include one or more instructions or computer codes. According to an example embodiment, the processor 210 may function as a control unit that operates by executing the program stored in the storage 230.

Moreover, according to an example embodiment, the processor 230 may execute the one or more instructions or computer codes to implement one or more modules to build AI models to manage, control and/or optimize one or more servers 100 of the network 1. According to an example embodiment, the processor 210 may control the operation of the apparatus 210. According to an example embodiment, the memory 220 may provide a memory field necessary for the operation of the processor 210. According to an example embodiment, the communication interface 240 may be connected to other devices, such as servers 101, in the network 1. According to an example embodiment, data may be transmitted or received from other devices in the network through the communication interface 240.

According to an example embodiment, the processor 210 may receive data from one or more servers 101 in the network 1. According to an example embodiment, the processor 210 may receive the data from a management server, which has collected the data about the one or more servers 101 in the network 1. According to another example embodiment, the processor 210 may receive and collect the data directly from the one or more servers 101 in the network 1. According to an example embodiment, the data may be relate to a characteristics of the one or more servers 101. For instance, the data may be server parameters related to the hardware components of servers 101 or the functionalities of the server 101. In some example embodiments, the server parameter includes a field programmable gate array (FPGA) parameter, a CPU parameter, a memory parameter, and/or an interrupt parameter. In some embodiments, the FPGA parameter is message queue, the CPU parameter is load and/or processes, the memory parameter is IRQ (interrupt request) or DISKIO (disk input/output operations), and the interrupt parameter is IPMI (intelligent Platform Management Interface) and/or IOWAIT (i.e., idle time).

The server parameters may include the following parameter show in Table 1 below.

TABLE_
Example of 535 Server Parameters

| | |
|---|---|
| 1. | kernel_context_switches |
| 2. | kernel_boot_time |
| 3. | kernel_interrupts |
| 4. | kernel_processes_forked |
| 5. | kernel_entropy_avail |
| 6. | process_resident_memory_bytes |
| 7. | process_cpu_seconds_total |
| 8. | process_start_time_seconds |
| 9. | process_max_fds |
| 10. | process_virtual_memory_bytes |
| 11. | process_virtual_memory_max_bytes |
| 12. | process_open_fds |
| 13. | ceph_usage_total_used |
| 14. | ceph_usage_total_space |
| 15. | ceph_usage_total_avail |
| 16. | ceph_pool_usage_objects |
| 17. | ceph_pool_usage_kb_used |
| 18. | ceph_pool_usage_bytes_used |
| 19. | ceph_pool_stats_write_bytes_sec |
| 20. | ceph_pool_stats_recovering_objects_per_sec |
| 21. | ceph_pool_stats_recovering_keys_per_sec |
| 22. | ceph_pool_stats_recovering_bytes_per_sec |
| 23. | ceph_pool_stats_read_bytes_sec |
| 24. | ceph_pool_stats_op_per_sec |
| 25. | ceph_pgmap_write_bytes_sec |
| 26. | ceph_pgmap_version |
| 27. | ceph_pgmap_state_count |
| 28. | ceph_pgmap_read_bytes_sec |
| 29. | ceph_pgmap_op_per_sec |
| 30. | ceph_pgmap_num_pgs |
| 31. | ceph_pgmap_data_bytes |
| 32. | ceph_pgmap_bytes_used |
| 33. | ceph_pgmap_bytes_total |
| 34. | ceph_pgmap_bytes_avail |
| 35. | ceph_osdmap_num_up_osds |
| 36. | ceph_osdmap_num_remapped_pgs |
| 37. | ceph_osdmap_num_osds |
| 38. | ceph_osdmap_num_in_osds |
| 39. | ceph_osdmap_epoch |
| 40. | ceph_health |
| 41. | ceph_pool_stats_write_op_per_sec |
| 42. | ceph_pgmap_write_op_per_sec |
| 43. | ceph_pool_stats_read_op_per_sec |
| 44. | ceph_pgmap_read_op_per_sec |
| 45. | conntrack_ip_conntrack_max |
| 46. | conntrack_ip_conntrack_count |
| 47. | go_memstats_mcache_sys_bytes |
| 48. | go_memstats_buck_hash_sys_bytes |
| 49. | go_memstats_stack_sys_bytes |
| 50. | go_memstats_heap_objects |
| 51. | go_gc_duration_seconds_sum |
| 52. | go_memstats_heap_idle_bytes |
| 53. | go_memstats_heap_released_bytes_total |
| 54. | go_memstats_other_sys_bytes |
| 55. | go_memstats_heap_sys_bytes |
| 56. | go_memstats_mcache_inuse_bytes |
| 57. | go_memstats_mspan_inuse_bytes |
| 58. | go_memstats_heap_inuse_bytes |
| 59. | go_memstats_stack_inuse_bytes |
| 60. | go_gc_duration_seconds |
| 61. | go_memstats_alloc_bytes |
| 62. | go_gc_duration_seconds_count |
| 63. | go_memstats_alloc_bytes_total |
| 64. | go_memstats_sys_bytes |
| 65. | go_memstats_heap_released_bytes |
| 66. | go_memstats_gc_cpu_fraction |
| 67. | go_memstats_gc_sys_bytes |
| 68. | go_memstats_mallocs_total |
| 69. | go_memstats_mspan_sys_bytes |
| 70. | go_memstats_lookups_total |
| 71. | go_memstats_next_gc_bytes |
| 72. | go_threads |
| 73. | go_memstats_last_gc_time_seconds |
| 74. | go_memstats_frees_total |
| 75. | go_goroutines |
| 76. | go_info |
| 77. | go_memstats_heap_alloc_bytes |
| 78. | cp_hypervisor_memory_mb_used |
| 79. | cp_hypervisor_running_vms |
| 80. | cp_hypervisor_up |
| 81. | cp_openstack_service_up |
| 82. | cp_hypervisor_memory_mb |
| 83. | cp_hypervisor_vcpus |
| 84. | cp_hypervisor_vcpus_used |
| 85. | disk_inodes_used |
| 86. | disk_total |
| 87. | disk_inodes_total |
| 88. | disk_free |
| 89. | disk_inodes_free |
| 90. | disk_used_percent |
| 91. | disk_used |
| 92. | ntpq_offset |
| 93. | ntpq_reach |
| 94. | ntpq_delay |
| 95. | ntpq_when |
| 96. | ntpq_jitter |
| 97. | ntpq_poll |
| 98. | system_load15 |
| 99. | system_n_cpus |
| 100. | system_uptime |
| 101. | system_n_users |
| 102. | system_load5 |
| 103. | system_load1 |
| 104. | scrape_samples_scraped |
| 105. | scrape_samples_post_metric_relabeling |
| 106. | scrape_duration_seconds |
| 107. | internal_memstats_heap_objects |
| 108. | internal_memstats_mallocs |
| 109. | internal_write_metrics_added |
| 110. | internal_write_write_time_ns |
| 111. | internal_memstats_heap_idle_bytes |
| 112. | internal_agent_metrics_written |
| 113. | internal_agent_metrics_gathered |
| 114. | internal_memstats_heap_in_use_bytes |
| 115. | internal_memstats_heap_sys_bytes |
| 116. | internal_memstats_heap_released_bytes |
| 117. | internal_gather_gather_time_ns |
| 118. | internal_write_buffer_limit |
| 119. | internal_agent_gather_errors |
| 120. | internal_memstats_frees |
| 121. | internal_agent_metrics_dropped |
| 122. | internal_write_metrics_dropped |
| 123. | internal_memstats_num_gc |
| 124. | internal_write_buffer_size |
| 125. | internal_gather_metrics_gathered |
| 126. | internal_memstats_alloc_bytes |
| 127. | internal_write_metrics_written |
| 128. | internal_write_metrics_filtered |
| 129. | internal_memstats_sys_bytes |
| 130. | internal_memstats_total_alloc_bytes |
| 131. | internal_memstats_pointer_lookups |
| 132. | internal_memstats_heap_alloc_bytes |
| 133. | diskio_iops_in_progress |
| 134. | diskio_io_time |
| 135. | diskio_read_time |
| 136. | diskio_writes |
| 137. | diskio_weighted_io_time |
| 138. | diskio_write_time |
| 139. | diskio_reads |
| 140. | diskio_write_bytes |
| 141. | diskio_read_bytes |
| 142. | net_icmpmsg_intype3 |
| 143. | net_icmp_inaddrmaskreps |
| 144. | net_icmpmsg_intype0 |
| 145. | net_tcp_rtoalgorithm |
| 146. | net_icmpmsg_intype8 |
| 147. | net_packets_sent |
| 148. | net_udplite_inerrors |
| 149. | net_udplite_sndbuferrors |
| 150. | net_conntrack_dialer_conn_closed_total |
| 151. | net_top_estabresets |
| 152. | net_icmp_indestunreachs |
| 153. | net_icmp_outaddrmasks |
| 154. | net_err_out |
| 155. | net_icmp_intimestamps |
| 156. | net_icmp_inerrors |
| 157. | net_ip_fragfails |
| 158. | net_ip_outrequests |
| 159. | net_udplite_rcvbuferrors |
| 160. | net_ip_inaddrerrors |
| 161. | net_tcp_insegs |
| 162. | net_tcp_incsumerrors |
| 163. | net_icmpmsg_outtype0 |
| 164. | net_icmpmsg_outtype3 |
| 165. | net_icmpmsg_outtype8 |
| 166. | net_icmp_intimestampreps |
| 167. | net_tcp_outsegs |
| 168. | net_ip_fragcreates |
| 169. | net_tcp_retranssegs |
| 170. | net_icmp_inechoreps |
| 171. | net_udplite_indatagrams |
| 172. | net_icmp_outtimestamps |
| 173. | net_ip_reasmoks |
| 174. | net_tcp_attemptfails |
| 175. | net_icmp_inmsgs |
| 176. | net_ip_reasmfails |
| 177. | net_ip_indelivers |
| 178. | net_icmp_intimeexcds |
| 179. | net_icmp_outredirects |
| 180. | net_ip_defaultttl |
| 181. | net_icmp_outtimeexcds |
| 182. | net_icmp_outechos |
| 183. | net_ip_forwarding |
| 184. | net_icmp_inechos |
| 185. | net_ip_indiscards |
| 186. | net_ip_reasmtimeout |
| 187. | net_udp_indatagrams |
| 188. | net_bytes_recv |
| 189. | net_icmp_outerrors |
| 190. | net_conntrack_listener_conn_accepted_total |
| 191. | net_icmp_inaddrmasks |
| 192. | net_err_in |
| 193. | net_tcp_passiveopens |
| 194. | net_icmp_outaddrmaskreps |
| 195. | net_udplite_incsumerrors |
| 196. | net_udp_noports |
| 197. | net_tcp_outrsts |
| 198. | net_drop_out |
| 199. | net_conntrack_dialer_conn_attempted_total |
| 200. | net_icmp_inparmprobs |
| 201. | net_icmp_insrcquenchs |
| 202. | net_drop_in |
| 203. | net_icmp_outtimestampreps |
| 204. | net_ip_inreceives |
| 205. | net_udplite_outdatagrams |
| 206. | net_ip_forwdatagrams |
| 207. | net_conntrack_listener_conn_closed_total |
| 208. | net_icmp_outsrcquenchs |
| 209. | net_icmp_outechoreps |
| 210. | net_tcp_rtomax |
| 211. | net_udp_rcvbuferrors |
| 212. | net_conntrack_dialer_conn_established_total |
| 213. | net_tcp_activeopens |
| 214. | net_ip_outnoroutes |
| 215. | net_tcp_currestab |
| 216. | net_ip_outdiscards |
| 217. | net_tcp_maxconn |
| 218. | net_udp_inerrors |
| 219. | net_tcp_rtomin |
| 220. | net_icmp_inredirects |
| 221. | net_icmp_outmsgs |
| 222. | net_icmp_outparmprobs |
| 223. | net_ip_reasmreqds |
| 224. | net_ip_inunknownprotos |
| 225. | net_udplite_noports |
| 226. | net_icmp_incsumerrors |
| 227. | net_ip_inhdrerrors |
| 228. | net_udp_incsumerrors |
| 229. | net_packets_recv |
| 230. | net_conntrack_dialer_conn_failed_total |
| 231. | net_bytes_sent |
| 232. | net_udp_sndbuferrors |
| 233. | net_udp_outdatagrams |
| 234. | net_tcp_inerrs |
| 235. | net_ip_fragoks |
| 236. | net_icmp_outdestunreachs |
| 237. | swap_out |
| 238. | swap_used |
| 239. | swap_free |
| 240. | swap_total |
| 241. | swap_in |
| 242. | swap_used_percent |
| 243. | http_response_result_code |
| 244. | http_response_http_response_code |
| 245. | http_response_response_time |
| 246. | mem_available_percent |
| 247. | mem_huge_page_stotal |
| 248. | mem_used |
| 249. | mem_total |
| 250. | mem_commit_limit |
| 251. | mem_available |
| 252. | mem_cached |
| 253. | mem_write_back |
| 254. | mem_dirty |
| 255. | mem_used_percent |
| 256. | mem_vmalloc_chunk |
| 257. | mem_page_tables |
| 258. | mem_high_free |
| 259. | mem_swap_free |
| 260. | mem_swap_total |
| 261. | mem_committed_as |
| 262. | mem_inactive |
| 263. | mem_low_total |
| 264. | mem_buffered |
| 265. | mem_huge_pages_free |
| 266. | mem_swap_cached |
| 267. | mem_vmalloc_total |
| 268. | mem_slab |
| 269. | mem_vmalloc_used |
| 270. | mem_wired |
| 271. | mem_high_total |
| 272. | mem_shared |
| 273. | mem_free |
| 274. | mem_write_back_tmp |
| 275. | mem_mapped |
| 276. | mem_huge_page_size |
| 277. | mem_low_free |
| 278. | mem_active |
| 279. | ipmi_sensor |
| 280. | ipmi_sensor_status |
| 281. | linkstate_partner |
| 282. | linkstate_actor |
| 283. | linkstate_sriov |
| 284. | prometheus_sd_kubernetes_cache_short_watches_total |
| 285. | prometheus_engine_query_duration_seconds_count |
| 286. | prometheus_tsdb_reloads_total |
| 287. | prometheus_template_text_expansion_failures_total |
| 288. | prometheus_target_scrape_pool_sync_total |
| 289. | prometheus_rule_group_duration_seconds_sum |
| 290. | prometheus_tsdb_checkpoint_deletions_total |
| 291. | prometheus_sd_openstack_refresh_failures_total |
| 292. | prometheus_target_interval_length_seconds_sum |
| 293. | prometheus_sd_gce_refresh_duration_count |
| 294. | prometheus_tsdb_compaction_chunk_size_bytes_count |
| 295. | prometheus_notifications_sent_total |
| 296. | prometheus_sd_consul_rpc_duration_seconds_sum |
| 297. | prometheus_http_request_duration_seconds_bucket |
| 298. | prometheus_tsdb_compaction_duration_seconds_bucket |
| 299. | prometheus_sd_ec2_refresh_duration_seconds_count |
| 300. | prometheus_sd_kubernetes_cache_list_duration_seconds_sum |
| 301. | prometheus_sd_dns_lookups_total |
| 302. | prometheus_template_text_expansions_total |
| 303. | prometheus_sd_triton_refresh_duration_seconds_sum |
| 304. | prometheus_sd_ec2_refresh_failures_total |
| 305. | prometheus_rule_group_duration_seconds |
| 306. | prometheus_sd_triton_refresh_failures_total |
| 307. | prometheus_sd_kubernetes_cache_list_items_count |
| 308. | prometheus_sd_kubernetes_events_total |
| 309. | prometheus_sd_file_scan_duration_seconds |
| 310. | prometheus_tsdb_wal_truncate_duration_seconds_sum |
| 311. | prometheus_sd_dns_lookup_failures_total |
| 312. | prometheus_engine_query_duration_seconds_sum |
| 313. | prometheus_sd_openstack_refresh_duration_seconds |
| 314. | prometheus_tsdb_head_max_time_seconds |
| 315. | prometheus_rule_evaluation_duration_seconds |
| 316. | prometheus_tsdb_head_series_created_total |
| 317. | prometheus_tsdb_head_truncations_total |
| 318. | prometheus_tsdb_checkpoint_creations_total |
| 319. | prometheus_tsdb_head_gc_duration_seconds_sum |
| 320. | prometheus_tsdb_head_chunks_removed_total |
| 321. | prometheus_sd_azure_refresh_failures_total |
| 322. | prometheus_http_response_size_bytes_sum |
| 323. | prometheus_sd_triton_refresh_duration_seconds |
| 324. | prometheus_tsdb_head_series_removed_total |
| 325. | prometheus_rule_group_interval_seconds |
| 326. | prometheus_notifications_latency_seconds_count |
| 327. | prometheus_http_request_duration_seconds_sum |
| 328. | prometheus_http_request_duration_seconds_count |
| 329. | prometheus_tsdb_tombstone_cleanup_seconds_count |
| 330. | prometheus_tsdb_compaction_chunk_range_seconds_sum |
| 331. | prometheus_tsdb_wal_fsync_duration_seconds |
| 332. | prometheus_target_sync_length_seconds_count |
| 333. | prometheus_sd_consul_rpc_duration_seconds_count |
| 334. | prometheus_tsdb_compaction_chunk_range_seconds_count |
| 335. | prometheus_sd_marathon_refresh_duration_seconds_sum |
| 336. | prometheus_tsdb_compactions_total |
| 337. | prometheus_target_sync_length_seconds |
| 338. | prometheus_tsdb_wal_fsync_duration_seconds_count |
| 339. | prometheus_sd_marathon_refresh_duration_seconds |
| 340. | prometheus_treecache_watcher_goroutines |
| 341. | prometheus_sd_updates_total |
| 342. | prometheus_tsdb_compaction_chunk_samples_bucket |
| 343. | prometheus_sd_openstack_refresh_duration_seconds_sum |
| 344. | prometheus_target_scrapes_sample_out_of_bounds_total |
| 345. | prometheus_tsdb_time_retentions_total |
| 346. | prometheus_notifications_queue_capacity |
| 347. | prometheus_tsdb_head_truncations_failed_total |
| 348. | prometheus_tsdb_wal_page_flushes_total |
| 349. | prometheus_sd_kubernetes_cache_list_items_sum |
| 350. | prometheus_sd_kubernetes_cache_last_resource_version |
| 351. | prometheus_http_response_size_bytes_bucket |
| 352. | prometheus_target_sync_length_seconds_sum |
| 353. | prometheus_tsdb_wal_corruptions_total |
| 354. | prometheus_notifications_alertmanagers_discovered |
| 355. | prometheus_rule_group_last_evaluation_timestamp_seconds |
| 356. | prometheus_sd_azure_refresh_duration_seconds |
| 357. | prometheus_sd_gce_refresh_duration |
| 358. | prometheus_notifications_latency_seconds_sum |
| 359. | prometheus_sd_gce_refresh_failures_total |
| 360. | prometheus_tsdb_compactions_triggered_total |
| 361. | prometheus_sd_azure_refresh_duration_seconds_count |
| 362. | prometheus_rule_evaluations_total |
| 363. | prometheus_rule_group_last_duration_seconds |
| 364. | prometheus_tsdb_wal_fsync_duration_seconds_sum |
| 365. | prometheus_target_interval_length_seconds |
| 366. | prometheus_tsdb_wal_completed_pages_total |
| 367. | prometheus_tsdb_head_max_time |
| 368. | prometheus_tsdb_checkpoint_creations_failed_total |
| 369. | prometheus_treecache_zookeeper_failures_total |
| 370. | prometheus_sd_marathon_refresh_failures_total |
| 371. | prometheus_tsdb_wal_truncations_total |
| 372. | prometheus_sd_openstack_refresh_duration_seconds_count |
| 373. | prometheus_tsdb_head_series_not_found_total |
| 374. | prometheus_tsdb_lowest_timestamp |
| 375. | prometheus_tsdb_compaction_chunk_size_bytes_bucket |
| 376. | prometheus_sd_kubemetes_cache_list_duration_seconds_count |
| 377. | prometheus_tsdb_head_active_appenders |
| 378. | prometheus_tsdb_wal_truncations_failed_total |
| 379. | prometheus_tsdb_compactions_failed_total |
| 380. | prometheus_sd_kubemetes_cache_watch_events_count |
| 381. | prometheus_rule_evaluation_duration_seconds_sum |
| 382. | prometheus_tsdb_compaction_chunk_samples_sum |
| 383. | prometheus_sd_consul_rpc_failures_total |
| 384. | prometheus_tsdb_storage_blocks_bytes_total |
| 385. | prometheus_sd_kubemetes_cache_watches_total |
| 386. | prometheus_tsdb_checkpoint_deletions_failed_total |
| 387. | prometheus_sd_ec2_refresh_duration_seconds_sum |
| 388. | prometheus_rule_group_rules |
| 389. | prometheus_notifications_errors_total |
| 390. | prometheus_sd_file_scan_duration_seconds_count |
| 391. | prometheus_tsdb_head_min_time_seconds |
| 392. | prometheus_tsdb_compaction_duration_seconds_count |
| 393. | prometheus_rule_group_iterations_total |
| 394. | prometheus_sd_ec2_refresh_duration_seconds |
| 395. | prometheus_engine_queries_concurrent_max |
| 396. | prometheus_engine_queries |
| 397. | prometheus_tsdb_wal_truncate_duration_seconds |
| 398. | prometheus_engine_query_duration_seconds |
| 399. | prometheus_tsdb_lowest_timestamp_seconds |
| 400. | prometheus_notifications_dropped_total |
| 401. | prometheus_sd_kubemetes_cache_watch_duration_seconds_count |
| 402. | prometheus_tsdb_compaction_chunk_samples_count |
| 403. | prometheus_sd_consul_rpc_duration_seconds |
| 404. | prometheus_rule_evaluation_failures_total |
| 405. | prometheus_sd_file_read_errors_total |
| 406. | prometheus_tsdb_head_chunks_created_total |
| 407. | prometheus_rule_group_iterations_missed_total |
| 408. | prometheus_tsdb_head_min_time |
| 409. | prometheus_tsdb_tombstone_cleanup_seconds_sum |
| 410. | prometheus_rule_evaluation_duration_seconds_count |
| 411. | prometheus_target_scrapes_sample_out_of_order_total |
| 412. | prometheus_notifications_queue_length |
| 413. | prometheus_tsdb_blocks_loaded |
| 414. | prometheus_tsdb_head_gc_duration_seconds_count |
| 415. | prometheus_sd_kubernetes_cache_list_total |
| 416. | prometheus_sd_discovered_targets |
| 417. | prometheus_target_scrapes_sample_duplicate_timestamp_total |
| 418. | prometheus_config_last_reload_success_timestamp_seconds |
| 419. | prometheus_sd_marathon_refresh_duration_seconds_count |
| 420. | prometheus_sd_triton_refresh_duration_seconds_count |
| 421. | prometheus_http_response_size_bytes_count |
| 422. | prometheus_notifications_latency_seconds |
| 423. | prometheus_config_last_reload_successful |
| 424. | prometheus_tsdb_head_series |
| 425. | prometheus_tsdb_compaction_chunk_size_bytes_sum |
| 426. | prometheus_tsdb_head_samples_appended_total |
| 427. | prometheus_api_remote_read_queries |
| 428. | prometheus_sd_gce_refresh_duration_sum |
| 429. | prometheus_rule_group_duration_seconds_count |
| 430. | prometheus_sd_kubernetes_cache_watch_events_sum |
| 431. | prometheus_sd_file_scan_duration_seconds_sum |
| 432. | prometheus_target_scrapes_exceeded_sample_limit_total |
| 433. | prometheus_tsdb_head_gc_duration_seconds |
| 434. | prometheus_build_info |
| 435. | prometheus_tsdb_compaction_duration_seconds_sum |
| 436. | prometheus_tsdb_size_retentions_total |
| 437. | prometheus_sd_azure_refresh_duration_seconds_sum |
| 438. | prometheus_tsdb_compaction_chunk_range_seconds_bucket |
| 439. | prometheus_tsdb_wal_truncate_duration_seconds_count |
| 440. | prometheus_target_interval_length_seconds_count |
| 441. | prometheus_tsdb_tombstone_cleanup_seconds_bucket |
| 442. | prometheus_tsdb_headchunks |
| 443. | prometheus_sd_received_updates_total |
| 444. | prometheus_tsdb_reloads_failures_total |
| 445. | prometheus_tsdb_symbol_table_size_bytes |
| 446. | prometheus_sd_kubernetes_cache_watch_duration_seconds_sum |
| 447. | haproxy_req_rate_max |
| 448. | haproxy_chkdown |
| 449. | haproxy_wredis |
| 450. | haproxy_chkfail |
| 451. | haproxy_active_servers |
| 452. | haproxy_econ |
| 453. | haproxy_qmax |
| 454. | haproxy_check_code |
| 455. | haproxy_lastsess |
| 456. | haproxy_bin |
| 457. | haproxy_downtime |
| 458. | haproxy_http_response_1xx |
| 459. | haproxy_backup_servers |
| 460. | haproxy_req_rate |
| 461. | haproxy_req_tot |
| 462. | haproxy_http_response_4xx |
| 463. | haproxy_qcur |
| 464. | haproxy_iid |
| 465. | haproxy_weight |
| 466. | haproxy_smax |
| 467. | haproxy_rate_max |
| 468. | haproxy_hanafail |
| 469. | haproxy_srv_abort |
| 470. | haproxy_wretr |
| 471. | haproxy_lastchg |
| 472. | haproxy_eresp |
| 473. | haproxy_stot |
| 474. | haproxy_dresp |
| 475. | haproxy_sid |
| 476. | haproxy_qtime |
| 477. | haproxy_comp_rsp |
| 478. | haproxy_dreq |
| 479. | haproxy_rate_lim |
| 480. | haproxy_cli_abort |
| 481. | haproxy_scur |
| 482. | haproxy_http_response_5xx |
| 483. | haproxy_comp_in |
| 484. | haproxy_rate |
| 485. | haproxy_ereq |
| 486. | haproxy_rtime |
| 487. | haproxy_lbtot |
| 488. | haproxy_ttime |
| 489. | haproxy_pid |
| 490. | haproxy_comp_out |
| 491. | haproxy_http_response_3xx |
| 492. | haproxy_ctime |
| 493. | haproxy_bout |
| 494. | haproxy_http_response_2xx |
| 495. | haproxy_slim |
| 496. | haproxy_check_duration |
| 497. | haproxy_http_response_other |
| 498. | haproxy_comp_byp |
| 499. | processes_sleeping |
| 500. | processes_paging |
| 501. | processes_unknown |
| 502. | processes_stopped |
| 503. | processes_total_threads |
| 504. | processes_running |
| 505. | processes_total |
| 506. | processes_zombies |
| 507. | processes_blocked |
| 508. | processes_idle |
| 509. | processes_dead |
| 510. | promhttp_metric_handler_requests_total |
| 511. | promhttp_metric_handler_requests_in_flight |
| 512. | up |
| 513. | hugepages_free |
| 514. | hugepages_surplus |
| 515. | hugepages_nr |
| 516. | docker_container_mem_usage |
| 517. | docker_container_mem_usage_percent |
| 518. | docker_container_status_finished_at |
| 519. | docker_n_containers_stopped |
| 520. | docker_container_status_exitcode |
| 521. | docker_container_cpu_usage_percent |
| 522. | docker_n_containers |
| 523. | docker_n_containers_paused |
| 524. | docker_n_containers_running |
| 525. | docker_container_status_started_at |
| 526. | cpu_usage_softirq |
| 527. | cpu_usage_guest |
| 528. | cpu_usage_guest_nice |
| 529. | cpu_usage_idle |
| 530. | cpu_usage_iowait |
| 531. | cpu_usage_steal |
| 532. | cpu_usage_nice |
| 533. | cpu_usage_user |
| 534. | cpu_usage_irq |
| 535. | cpu_usage_system |

However, the disclosure is not limited to the server parameters listed above. For instance, according to another example of the disclosure, the data may include other parameter, metrics or performance indicators. For instance, the data may include key performance indicators (KPI). As such, processor may receive large number of data points.

According to an example embodiment, the processor 210 may perform a clustering operation on the data. For instance, the processor 210 may apply a clustering algorithm on the data to identify patterns across multiple servers 101. According to an example embodiment, the clustering algorithm may implement machine learning to group data points in the data into similar clusters based on features of the data points. For instance, the processor 210 may cluster the servers 101 operating across different geographical regions and/or performing multiple workloads running different protocols based on their workload signatures, time of the day patterns, network traffic patterns, kernel statistics, etc.

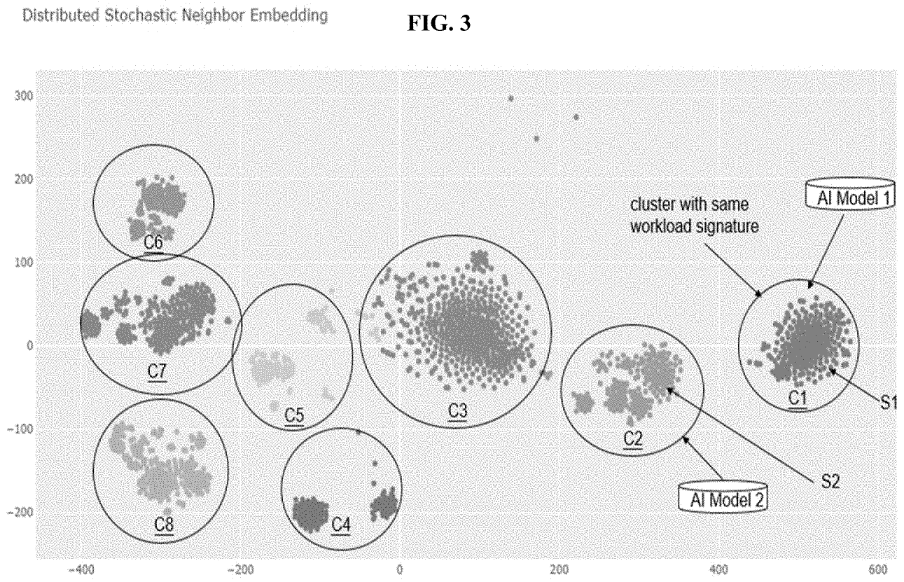

Referring to FIG. 3, the processor 210 may cluster the data points into clusters C1-C8 based on features of the data points. For instance, each of the clusters C1-C8 may include a group of servers 101. According to an example embodiment, each dot inside a cluster may represent a server having certain pattern that is same or similar to other servers in the cluster. As shown in FIG. 3, cluster C1 may include a plurality of first servers that have same workload signatures or similar workload signatures. However, the disclosure is not limited thereto, and as such, each clusters C2-C8 may include a plurality of servers that have same respective patterns or similar respective patterns. For instance, a server satisfying a specific criteria or threshold with respect to a particular pattern of a cluster may be considers as part of the cluster.

According to an example embodiment, the processor 210 may build an AI model for each cluster of servers to take advantage of patterns that are specific to each cluster. For instance, the processor 210 may build a first AI model (AI Model 1) corresponding to a first cluster C1. In particular, the processor 210 may build the first AI model (AI Model 1) corresponding to the servers in the first cluster C1. Also, the processor 210 may build the second AI model (AI Model 2) corresponding to the servers in the second cluster C2. Each of the AI models, such as AI Model 1 and AI Model 2, are built or trained using test data. The test data may be historical data collected from the servers.

According to an example embodiment, the model training may be performed by: (1) loading data for training (i.e., historical data for servers); (2) setting targets based on a condition of the servers (obtain labels by labelling nodes based on the condition using the data), (3) computing statistical features of the data, and adding the statistical features to the data object, (4) identifying leading indicators for the condition, this identification is based on the data and the labels, (5) training an AI model with the leading indicators, the data, and the labels, and (6) optimizing the AI model by performing hyperparameter tuning and model validation. The output from operations (1)-(6) may be optimize the AI model by performing hyperparameter tuning and model validation (some of the historical data has been used for training, some has been reserved for testing at this stage). The output of the above approach is the AI model. According to another example embodiment, the training of the AI model may be performed by unlabeled data.

According to an example embodiment, in operation (2), the targets may be set based on the clusters. For instance, the model may be trained by taking into account the specific patterns identified for the servers in each of the clusters, such that the trained AI models are tailored for each cluster. For instance, the AI model for cluster C1 may be trained by setting the targets based on a workload signature. However, the disclosure is not limited thereto, and as such, other patterns, such as time of the day patterns, network traffic patterns, kernel statistics etc., may be used as targets for training the model.

According to an example embodiment, the processor 210 may deploy a plurality of AI models. Accordingly, each of the AI models corresponding to each of the respective servers in each of the respective clusters may be deployed, such that, a same AI model is used for each sever in a respective cluster. For instance, a first AI model (AI Model 1) corresponding to a first cluster C1 may be deployed with respect to a first server S1 in the first cluster C1. Also, a second AI model (AI Model 2) corresponding to a second cluster C2 may be deployed with respect to a second server S2 in the second cluster C2. Moreover, the first AI model is deployed for all the servers in cluster C1, and the second AI model is deployed for all the servers in cluster C2. Also, the processor 210 may build a third AI model corresponding to servers in cluster C3, a fourth AI model corresponding to servers in cluster C4, a fifth AI model corresponding to servers in cluster C5, a sixth AI model corresponding to servers in cluster C6, a seventh AI model corresponding to servers in cluster C7, and an eight AI model corresponding to servers in cluster C8. However, the disclosure is not limited to the clusters in FIG. 3 and the AI models corresponding to the clusters. As such, according to another example embodiment, different number of clusters and AI models may be provided.

According to an example embodiment, the AI models may predict one or more future characteristics of the servers 101. For instance, the first AI model may predict one or more characteristics of one or more servers in the first cluster C1. Also, the second AI model may predict one or more characteristics of one or more servers in the second cluster C2. According to an example embodiment, one or more characteristics may be traffic on each of the servers over a period of time in the future. According to an example embodiment, one or more characteristics may be traffic on each core of the servers. For instance, the first AI model may predict the traffic on each core of the one or more servers in the first cluster over the next ten minutes. However, the disclosure is not limited thereto, and as such, according to other example embodiments, one or more characteristics may be different from the traffic and the period of time may be different from ten minutes.

According to an example embodiment, the optimization apparatus may output setting information corresponding to one or more features and/or functionalities of the servers based on the predicted one or more characteristics of the servers. For instance, the setting information may correspond to a CPU frequency based on the predicted one or more characteristics of the servers. However, the disclosure is not limited thereto, and as such, according to another example embodiment, the setting information may indicate a state of one or more servers based on the predicted one or more characteristics of the servers. For example, the setting information may indicate an operation state of the servers.

According to an example embodiment, the setting information may indicate that the one or more servers operate in a certain state, among a plurality of operation states. The operation state indicated in the setting information being determined based on the predicted one or more characteristics of the servers. According to an example embodiment, the operation state may be related to the processing frequency of the CPU. For instance, the operation states may be a first state, in which, the CPU frequency is set to 2.6 GHz, a second state, in which, the CPU frequency is set to or 2 GHZ or a third state, in which, the CPU frequency is set to 1.6 GHz. However, the disclosure is not limited thereto, and the operation states may be related to other features or functionalities of the servers.

According to an example embodiment, the optimization apparatus may control one or more servers based on the predicted one or more characteristics of the servers. For instance, optimization apparatus may output instruction to control the core of the one or more servers to operate at a specific frequency. According to another example embodiment, the optimization apparatus may output a recommendation to operate the one or more servers in a particular manner based on the predicted one or more characteristics of the servers.

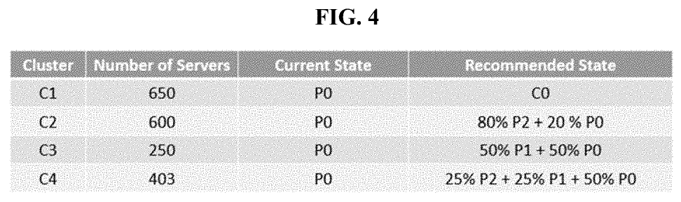

FIG. 4 illustrates operating states of the servers according to an example embodiment. For instance, row 1 may correspond to servers in the first cluster C1, row 2 may correspond to servers in the second cluster C2, row 3 may correspond to servers in the third cluster C3 and row 4 may correspond to servers in the fourth cluster C4. According to an example embodiment, the current state of all the servers in all the clusters may be P0. According to an example embodiment, state P0 may represent a CPU frequency of 2.6 GHz or a maximum frequency. According to an example embodiment, based on a predicted using the AI model described in the disclosure, the servers in the first cluster C1 may have a recommended state of C0, which is a normal operating state.

According to an example embodiment, based on a predicted using the AI model described in the disclosure, the servers in the second cluster C2 may have a recommended state, in which, the servers operate at state P2 eighty percent (80%) of the time and operate at state P0 twenty percent (20%) of the time. Here, P2 may represent a CPU frequency of 1.6 GHz.

According to an example embodiment, based on a predicted using the AI model described in the disclosure, the servers in the third cluster C3 may have a recommended state, in which, the servers operate at state P1 fifty percent (50%) of the time and operate at state P0 fifty percent (50%) of the time. Here, P1 may represent a CPU frequency of 2 GHz.

According to an example embodiment, based on a predicted using the AI model described in the disclosure, the servers in the fourth cluster C4 may have a recommended state, in which, the servers operate at state P2 twenty five percent (25%) of the time, operate at state P1 twenty five percent (25%) of the time and operate at state P0 fifty percent (50%) of the time.

Although FIG. 9 illustrates four recommended states, the disclosure is not limited thereto, and as such according to another example embodiment, other recommended states may be determined and output. According to an example embodiment, the servers may be controlled to operate based on the recommended states.

FIG. 2B illustrates an example embodiment of an apparatus 200 connected to a plurality of servers in network. According to an example embodiment, the optimization apparatus 200 may be connected to the servers 101_1, 101_2 and 101_3 through a management server. For example, the management server may be an edge node of the servers. According to an example embodiment of the disclosure, the optimization apparatus 200 may transmit the setting information for the servers 101_1, 101_2 and 101_3 to the management server based on the predicted one or more characteristics of the servers using the AI models.

FIG. 2C illustrates a detailed diagram of an apparatus 200 according to an example embodiment. In FIG. 2C, the apparatus 200 may include the same components illustrated in FIG. 2A. However, the diagram of the apparatus 200 in FIG. 2C may further illustrate the modules implemented by the processor 210. According to an example embodiment, the processor 210 may execute one or more instructions (or program codes) to implement a clustering module 211, a model builder 212, a predictor 213 and an output module 214.

According to an example embodiment, the clustering module 211 may classify the plurality of devices in the network into a plurality of clusters based on the data. According to an example embodiment, the clustering module 211 may capture the patterns across multiple servers, and cluster the plurality of servers based on the captured patterns. According to an example embodiment, the classification operation may be performed using machine learning.

According to an example embodiment, the model builder 212 may build a plurality of artificial intelligence (AI) models, each of the AI models corresponding to one of the plurality of clusters. For instance, an AI model may be built respectively for each cluster of servers to take advantage of patterns that are specific to each cluster.

According to an example embodiment, the predictor 213 may deploy a plurality of AI models and determine a predicted operational characteristic for a first device based on the deployed AI model. That is, the predictor 213 may deploy the AI models to predict one or more future characteristics of one or more of the servers. According to an example embodiment, one of the characteristics may be traffic on each of the servers over a period of time in the future. According to an example embodiment, one or more characteristics may be traffic on each core of the servers. However, the disclosure is not limited thereto, and as such, according to other example embodiments, other characteristics such as a processing load on the servers or the memory usage of the servers.

According to an example embodiment, the output module 214 may output a recommendation for the first device based on the predicted operational characteristics. The output setting information may correspond to one or more features and/or functionalities of the servers based on the predicted one or more characteristics of the servers. For instance, the setting information may correspond to a CPU frequency based on the predicted one or more characteristics of the servers.

According to an example embodiment, the apparatus 200 illustrated in FIGS. 2A, 2B and 2C may be an operating console computer, which further include a display and a user interface.

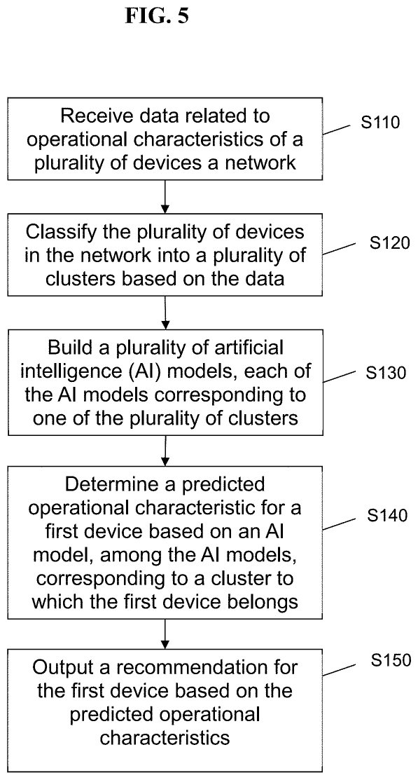

FIG. 5 illustrates a flow chart of operations in an optimization method according to an example embodiment. The operations illustrated in FIG. 5 may be performed one or more processor. For instance, the operations illustrated in FIG. 5 may be performed by a single processor or by two or more processors working in combination.

According to an example embodiment, the method includes receiving data related to operational characteristics of a plurality of devices a network (S110). For instance, the data may be received from one or more servers in a network. According to an example embodiment, the data may be relate to a characteristics of the one or more servers, i.e., server parameters related to the hardware components of servers or the functionalities of the server.

According to an example embodiment, the method includes classifying the plurality of devices in the network into a plurality of clusters based on the data (S120). According to an example embodiment, the classifying operation may be a clustering operation to capture the patterns across multiple servers, across different geographical regions, and/or multiple workloads running different protocols based on their workload signatures, time of the day patterns, network traffic patterns, kernel statistics, etc. Accordingly, the plurality of servers are clustered based on the captured patterns. According to an example embodiment, the classification operation may be performed using machine learning.

According to an example embodiment, the method includes building a plurality of artificial intelligence (AI) models, each of the AI models corresponding to one of the plurality of clusters (S130). For instance, an AI model may be built respectively for each cluster of servers to take advantage of patterns that are specific to each cluster. Accordingly, a plurality of AI models are deployed, each of the AI models corresponding to each of the respective servers in each of the respective clusters, such that, a same AI model is used for each sever in a respective cluster.

According to an example embodiment, the method includes determining a predicted operational characteristic for a first device based on an AI model corresponding to a cluster to which the first device belongs (S140). That is, the AI models may predict one or more future characteristics of one or more of the servers. According to an example embodiment, one of the characteristics may be traffic on each of the servers over a period of time in the future. According to an example embodiment, one or more characteristics may be traffic on each core of the servers. However, the disclosure is not limited thereto, and as such, according to other example embodiments, other characteristics such as a processing load on the servers or the memory usage of the servers.

According to an example embodiment, the method includes outputting a recommendation for the first device based on the predicted operational characteristics (S150). The output setting information may correspond to one or more features and/or functionalities of the servers based on the predicted one or more characteristics of the servers. For instance, the setting information may correspond to a CPU frequency based on the predicted one or more characteristics of the servers.

According to an example embodiment, the setting information may indicate a state of one or more servers based on the predicted one or more characteristics of the servers. For example, the setting information may indicate an operation state of the servers being determined based on the predicted one or more characteristics of the servers. According to an example embodiment, the operation states may be a first state, in which, the CPU frequency is set to 2.6 GHz, a second state, in which, the CPU frequency is set to or 2 GHZ or a third state, in which, the CPU frequency is set to 1.6 GHz. However, the disclosure is not limited thereto, and the operation states may be related to other features or functionalities of the servers.

According to an example embodiment, the method may include transmitting a control signal to one or more servers based on the predicted one or more characteristics of the servers. For instance, the method may include outputting instructions to control the core of the one or more servers to operate at a certain frequency on the predicted one or more characteristics of the servers. According to another example embodiment, the method may include output instructions to control the one or more servers to operate at an increased or a reduced speed. According to another example embodiment, the method may include output instructions to control the one or more servers to operate using less resources. However, the disclosure is not limited thereto. and as such, according to another example embodiment, other output or control setting are possible based on frequency on the predicted one or more characteristics of the servers.

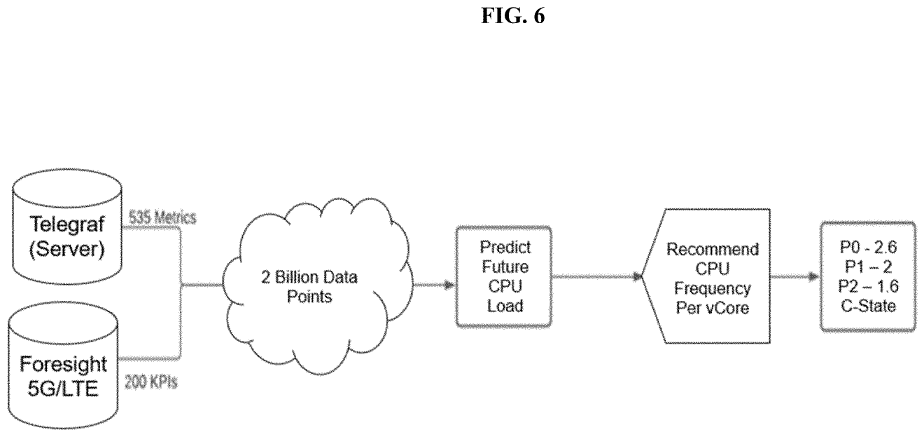

FIG. 6 illustrates a process flow according to an example embodiment of the disclosure. According to an example embodiment, the optimization apparatus receive data from telegraf server and/or foresight (5G/LTE) servers. According to an example embodiment, the data may include 2 billion data points made of 535 metrics and/or 200 key performance indicators (KPIs). However, the disclosure is not limited thereto, and as such, different amount of data may be received and processed by the optimization apparatus.

According to an example embodiment, the optimization apparatus classifies the plurality of servers in the network into a plurality of clusters based on the data. Based on the plurality of clusters, the optimization apparatus builds a plurality of artificial intelligence (AI) models, each of the AI models corresponding to one of the plurality of clusters. The optimization apparatus may predict future CPU load based on the AI models and recommend CPU frequency based on the predicted future CPU load. The recommend CPU frequency may be one or a combination of the following states: C0, P0, P1, and P2. However, the disclosure is not limited thereto, and as such, other states are possible.

According to an example embodiment, the method includes determining a predicted operational characteristic for a first device based on an AI model corresponding to a cluster to which the first device belongs (S140). That is, the AI models may predict one or more future characteristics of one or more of the servers. According to an example embodiment, one of the characteristics may be traffic on each of the servers over a period of time in the future. According to an example embodiment, one or more characteristics may be traffic on each core of the servers. However, the disclosure is not limited thereto, and as such, according to other example embodiments, other characteristics such as a processing load on the servers or the memory usage of the servers.

According to an example embodiment, the method includes outputting a recommendation for the first device based on the predicted operational characteristics (S150). The output setting information may correspond to one or more features and/or functionalities of the servers based on the predicted one or more characteristics of the servers. For instance, the setting information may correspond to a CPU frequency based on the predicted one or more characteristics of the servers.

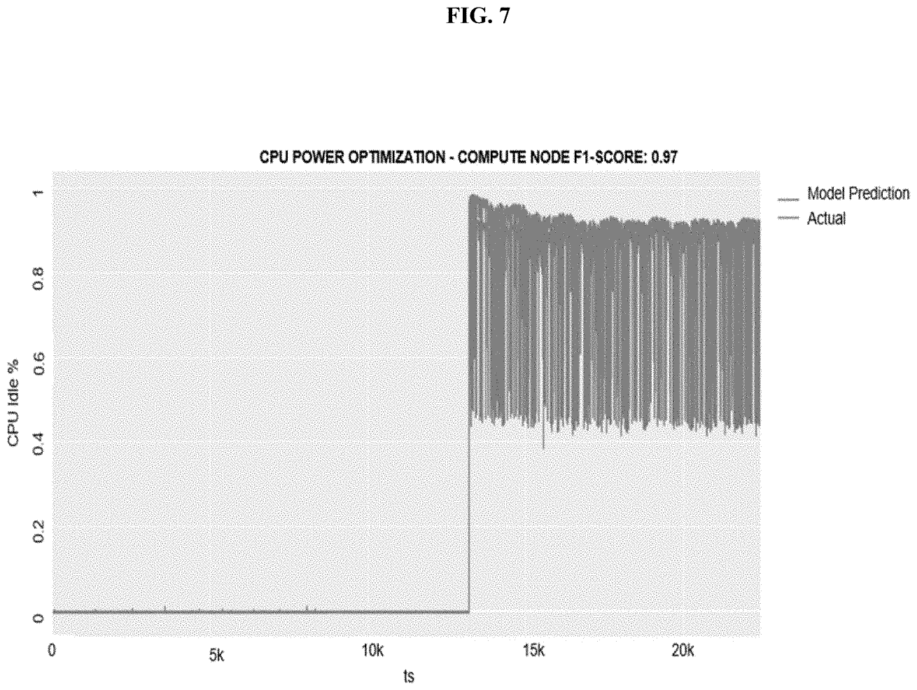

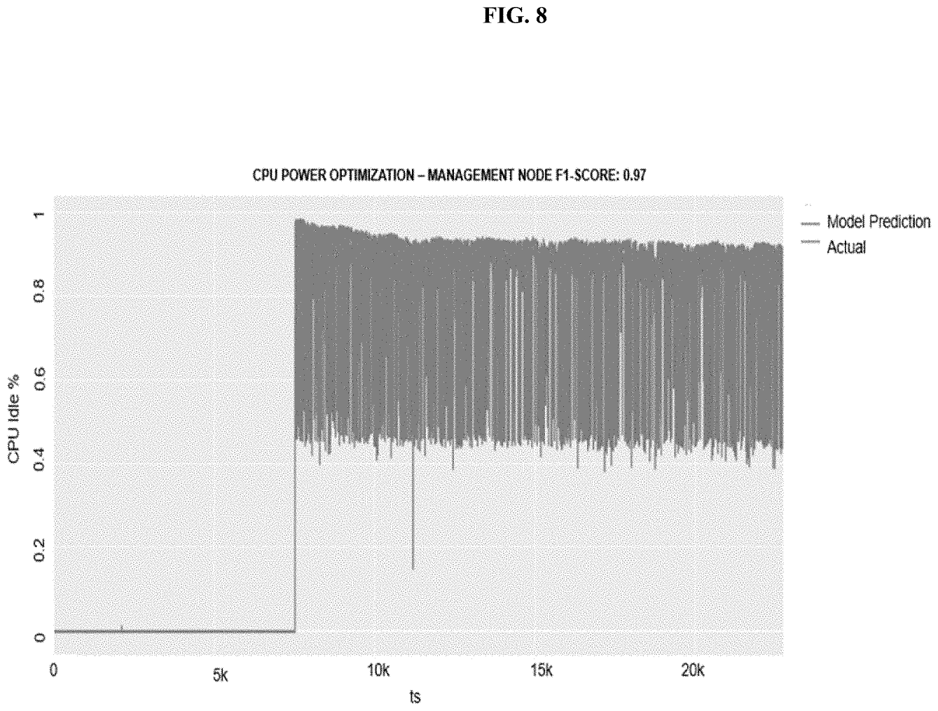

FIGS. 7 and 8 are graphs illustrating a level of accuracy of the prediction according to example embodiments. For instance, FIG. 7 shows that the prediction based on the AI models build for each clusters and applied at the compute nodes was 97% accurate. That is, the prediction has an F1 score of 0.97 for the compute node according to an example embodiment. Moreover, FIG. 8 shows that the prediction based on the AI models build for each clusters and applied at the management node was 97% accurate. That is, the prediction has an F1 score of 0.99 for the management node according to an example embodiment.

The scope of one or more example embodiments also includes a processing method of storing, in a storage medium, a program that causes the configuration of the example embodiment to operate to implement the function of the example embodiment described above, reading out as a code the program stored in the storage medium, and executing the code in a computer. That is, a computer readable storage medium is also included in the scope of each example embodiment. Further, not only the storage medium in which the program described above is stored but also the program itself is included in each example embodiment. Further, one or more components included in the example embodiments described above may be a circuit such as an Application Specific Integrated Circuit (ASIC), a Field Programmable Gate Array (FPGA), or the like configured to implement the function of each component.

As the storage medium, for example, a floppy (registered trademark) disk, a hard disk, an optical disk, a magneto-optical disk, a Compact Disk (CD)-ROM, a magnetic tape, a nonvolatile memory card, or a ROM can be used. Further, the scope of each of the example embodiments includes an example that operates on Operating System (OS) to perform a process in cooperation with another software or a function of an add-in board without being limited to an example that performs a process by an individual program stored in the storage medium.

Note that all the example embodiments described above are mere examples of embodiments in implementing the disclosure, and the technical scope of the disclosure should not be construed in a limiting sense by these example embodiments. That is, the disclosure can be implemented in various forms without departing from the technical concept thereof or the primary feature thereof.

1. An apparatus comprising:
a memory storing one or more instructions; and
a processor configured to execute the one or more instructions to:
receive data related to operational characteristics of a plurality of devices in a network,
classify the plurality of devices in the network into a plurality of clusters based on the data,
build a plurality of artificial intelligence (AI) models, each of the AI models corresponding to one of the plurality of clusters,
deploy a first AI model, among the plurality of AI models, for a first device, the first AI model corresponding to a first cluster to which the first device belongs, among the plurality of clusters,
determine a first predicted operational characteristic for the first device based on deployment of the first AI model, and
output a recommendation for the first device based on the first predicted operational characteristic.

2. The apparatus of claim 1, wherein the processor is further configured to execute a clustering algorithm classify the plurality of devices in the network into the plurality of clusters.

3. The apparatus of claim 1, wherein each of the plurality of AI models are tailored to one of the plurality of clusters.

4. The apparatus of claim 1, wherein the processor is further configured to control an operation parameter of a CPU of the first device based on the first predicted operational characteristic.

5. The apparatus of claim 1, wherein the processor is further configured to set a clock frequency of a CPU of the first device based on the first predicted operational characteristic.

6. The apparatus of claim 1, wherein the data comprises at least one of historical data including one of server parameters, metrics or key performance indicators.

7. The apparatus of claim 1, wherein the processor is further configured to classify the plurality of devices in the network into the plurality of clusters based on one or more patterns identified in the data.

8. The apparatus of claim 7, wherein the one or more patterns may be workload signature information, kernel statistics information, traffic pattern information, time information or location information.

9. A method comprising:
receiving data related to operational characteristics of a plurality of devices in a network;
classifying the plurality of devices in the network into a plurality of clusters based on the data;
building a plurality of artificial intelligence (AI) models, each of the AI models corresponding to one of the plurality of clusters;
deploying a first AI model, among the plurality of AI models, for a first device, the first AI model corresponding to a first cluster to which the first device belongs, among the plurality of clusters,
determining a first predicted operational characteristic for the first device based on deployment of the first AI model; and
outputting a recommendation for the first device based on the predicted operational characteristic.

10. The method of claim 9, further comprising executing a clustering algorithm classify the plurality of devices in the network into the plurality of clusters.

11. The method of claim 9, wherein each of the plurality of AI models are tailored to one of the plurality of clusters.

12. The method of claim 9, further comprising controlling an operation parameter of a CPU of the first device based on the first predicted operational characteristic.

13. The method of claim 9, further comprising setting a clock frequency of a CPU of the first device based on the first predicted operational characteristic.

14. The method of claim 9, wherein the data comprises at least one of historical data including one of server parameters, metrics or key performance indicators.

15. The method of claim 9, further classifying the plurality of devices in the network into the plurality of clusters based on one or more patterns identified in the data.

16. The method of claim 15, wherein the one or more patterns may be workload signature information, kernel statistics information, traffic pattern information, time information or location information.

17. The apparatus of claim 1, wherein the processor is further configured to execute the one or more instructions to:
deploy a second AI model, among the plurality of AI models, for a second device, the second AI model corresponding to a second cluster to which the second device belongs, among the plurality of clusters,
determine a second predicted operational characteristic for the second device based on deployment of the second AI model, and
output a recommendation for the second device based on the second predicted operational characteristic.

18. The apparatus of claim 1, wherein the first predicted operational characteristic is one of a predicted traffic or a predicted CPU load for the first device in the future.

19. The method of claim 9, further comprising:
deploying a second AI model, among the plurality of AI models, for a second device, the second AI model corresponding to a second cluster to which the second device belongs, among the plurality of clusters,
determining a second predicted operational characteristic for the second device based on deployment of the second AI model, and
outputting a recommendation for the second device based on the second predicted operational characteristic.

20. The method of claim 9, wherein the first predicted operational characteristic is one of a predicted traffic or a predicted CPU load for the first device in the future.
